(19) United States
(12) Patent Application Publication
(10) Pub. No.: US 2012/0254200 A1
(43) Pub. Date: Oct. 4, 2012

(54) USER BEHAVIOR BASED COGNITIVE ENGINE FOR DATA OBJECTS

(76) Inventors: Zvi Lifshitz, Jerusalem (IL); Ehud Spiegel, Petach Tikva (IL)

(21) Appl. No.: 13/437,217

(22) Filed: Apr. 2, 2012

Related U.S. Application Data
(60) Provisional application No. 61/470,505, filed on Apr. 1, 2011.

(51) Int. Cl. G06F 17/30

(52) U.S. Cl. 707/752; 707/E17.033; 707/E17.032

(57) ABSTRACT

A method and system for relating data objects according to a numerical cognitive association based on user behavior in accessing and/or retrieving the data objects. The resulting associations allow organizing the data objects in non-linear cognitive mappings which can be graphically rendered as cognitive maps. A method for merging multiple cognitive maps into a single cognitive map when cognitive associations exceed a predetermined threshold is provided; and a method for splitting a single cognitive map into multiple cognitive maps when cognitive associations fall below a predetermined threshold is also provided.

### REFERENCE TO RELATED APPLICATION

Reference is hereby made to U.S. Provisional Patent Application Ser. No. 61/470,505, filed Apr. 1, 2011, entitled “System and method for organization of items in a non-linear comment system”, the disclosure of which is hereby incorporated by reference and priority of which is hereby claimed pursuant to 37 CFR 1.78(a) (4) and (5)(i).

### FIELD

The present invention relates to computer applications in general, and more particularly to determining cognitive associations of stored data objects for retrieval and access according to the behavior of users with respect to the data objects.

### BACKGROUND

A common practice in the field of data access and retrieval is to classify data objects according to “relevance”, as determined by embedded text and/or hypertext content. Ordinary text documents are typically classified by relevance according to the statistics of certain search keywords and/or search key phrases contained in the document, and hypertext documents (e.g., web pages) are typically classified further according to embedded hypertext links to and from other hypertext documents. For example, the results of certain relevance-based searches for web pages are ordered, at least in part, according to the number of other web pages that link to the found web pages.

Although classification by relevance (as described above) has proven to be effective in facilitating access and retrieval of data objects, there are significant restrictions on the applicability of relevance classification. In particular, data objects which lack text and/or hypertext (e.g., pure graphics, audio, and video) cannot readily be classified according to relevance. In addition, the use of search keywords in assessing relevance is often subject to interpretation that results in over-selection and/or under-selection, frequently both at the same time.

The field of cognitive classification aims to avoid the restrictions and limitations of relevance classification by establishing advanced criteria for data object classification. Current cognitive classification techniques, however, require manually defining lists of cognitive properties, and manually assigning attributes to each of the data objects being searched according to the defined cognitive properties. Not only is this manual work tedious and labor-intensive, but it is also prone to omissions, human error, and differing subjective interpretations.

### SUMMARY

Embodiments of the present invention provide methods and systems for automatically determining a numerical cognitive association between pairs of stored data objects solely according to observed user behavior with respect to the data objects, without requiring the definition of cognitive properties, assignment of cognitive attributes, nor requiring reliance on any keywords or key phrases.

According to embodiments of the invention, user behavior is gauged and interpreted according to objective criteria, such as the duration and frequency of access to specific data objects, along with related quantities measured during the user's access of the data objects. Reports of the user's behavior patterns are sent automatically to a central server by a dedicated active agent in the user's computer. This process is performed for a group of users accessing similar data objects, in order to organize the objects non-linearly, in a cognitive map corresponding to a graph of nodes and edges, where the edges are characterized by the cognitive association between the data objects represented by the nodes.

In certain embodiments of the invention, a cognitive association is a number ranging from zero to one.

In additional embodiments, the cognitive map corresponds to a directed graph, in recognition that cognitive association is not necessarily symmetrical—for example, a couple engaged to be married may put up a web page listing the details of wedding gifts they prefer to receive. A website of a department store which sells these items may have a very high cognitive association (equal to, or close to 1.000) with their web page. Their web page, however, would probably have a very low cognitive association (equal to, or close to 0.000) with the department store's website. This is because most people who access the couple's web page would likely be highly interested in accessing the department store's website—but most people who access the department store's website would probably have little or no interest in the couple's web page.

In addition, embodiments of the present invention provide methods for merging disjoint cognitive maps corresponding to separate data object collections into a single cognitive map, when cognitive associations between the separate collections are sufficiently high according to a predetermined threshold. Further embodiments also provide methods for splitting a single cognitive map into separate disjoint cognitive maps, when cognitive associations within the single cognitive map are sufficiently low according to a predetermined threshold.

### DEFINITIONS

The term “data object” herein refers to any encapsulated collection of machine-readable data stored in non-transient tangible storage media, non-limiting examples of which include: websites and web pages; data files; documents; images; articles; video and/or audio files; and text, such as textual comments.

In the present disclosure a “blog” refers to a computerized system, such as a website or an organizational discussion board, featuring textual, visual, audible or hybrid data objects, along with a comment system through which users may comment on the data objects or on other comments. Well-known examples for a blog include web logs, newspaper articles with a talkback system, and Tweeter or Facebook's “wall”.

In discussions of the present disclosure related to blogs, the term “data object” may refer more specifically to a featured article or a comment in a blog.

In the present disclosure the “time” of a data object is the time in which the data object was first added to a system.

In the present disclosure “review” is an action (which may be performed by a visitor of a blog) of accessing a data object or a part thereof. The term “reviewer” is a person who reviews a data object or a group of data objects.

In the present disclosure “reply” is an action performed by a reviewer of a data object, of adding a new data object (such as to a blog) as a reaction to reviewing the data object.

According to embodiments of the invention, data objects are related to other data objects in “cognitive mappings” (also referred to herein as “cognitive maps”, particularly in the case of graphical renditions), which are collections of data objects which are determined to have a significant non-zero cognitive association with one another. In these embodiments, a data object is a “parent” to a “child” data object when the child data object has a sufficiently-high cognitive association with the parent. Similarly, data objects that have a common parent are “siblings”. A relationship between data objects is created in a method which is implementation dependent, for example when a child data object is added to a blog as a reply to a parent data object.

In the present disclosure a “reference” is an association made by a reviewer, between two data objects existing in the system. A reference may have a direction, e.g. one data object is the “referring” data object, in which case the other data object is the “referred” data object.

In the present disclosure a “topic” refers to a set of data objects that are related in some meaningful way. For example a cognitive mapping of data objects, along with their referring data objects or referred data objects are considered a topic.

A linear comment system is a comment system which is ordered chronologically, e.g., some data objects are the children of one or more data objects that precede them in time.

A linear comment system is natively organized chronologically, although a search mechanism may facilitate data object retrieval by various attributes.

According to certain embodiments of the invention a linear comment system may have a hierarchical structure, e.g. some data objects are the parents of zero, one or more children.

Also the structure of a linear comment system may be static, e.g. data objects can be added to the blog and also be removed from it, but parent-children relationship between specific data objects typically remains fixed.

According to embodiments of the invention, a non-linear system is a system in which data objects have optional cognitive mappings with other data objects regardless of the time of the data objects. Relationships between data objects in a non-linear comment system may be created by reviewers which, for example, may designate one or more data objects as a reply to one or more other data objects. In certain embodiments, such as those related to blogs, a non-linear system is a non-linear comment system.

A non-linear system has no native order.

In embodiments of the invention, the structure of a non-linear system is not necessarily hierarchical. For example, let a, b and c be data objects in a non-linear system so that a is a parent of b and b is the parent of c. Then it is possible that c is a parent of a.

The structure of a non-linear system is dynamic, e.g. relationships between data objects may vary along the lifespan of the system. Consequently, new cognitive mappings may be created, merged, and split.

The present invention provides a method for dynamically creating, merging and splitting topics by using a subjective relation between data objects. Two data objects are considered to belong to the same topic when it is likely that a reviewer of one data object will be interested to review the other data object. The present invention uses the behavior pattern of at least some of the reviewers to dynamically create, modify, and remove relationships of several types between data objects of the same or different topics.

The present invention provides a method for ordering data objects in relation to other data objects in an order that is based on cognitive association. According to embodiments of the invention, a data object has a higher cognitive association with a related data object when it is more likely that a reviewer of the related data object will be interested in reviewing the data object itself. The present invention uses the behavior pattern of at least some of the reviewers to dynamically weigh the cognitive association between data objects.

The present invention provides a method to quantify cognitive association by measuring the behavior pattern of reviewers according to a set of measurable parameters.

### BRIEF DESCRIPTION OF THE DRAWINGS

The present invention will be understood and appreciated more fully from the following detailed description taken in conjunction with the appended drawings in which:

FIG. 1 illustrates an example of relationships between data objects in a system according to an embodiment of the invention.

FIG. 2 illustrates reviewer behaviors in an example of a non-linear comment system according to an embodiment of the invention.

FIG. 3 illustrates a cognitive association table according to an embodiment of the invention.

FIG. 4 illustrates a method of cognitive association calculation according to an embodiment of the invention.

FIG. 5 illustrates an example of a cognitive association graph according to an embodiment of the invention.

FIG. 6 illustrates an example of a merge of cognitive mappings according to an embodiment of the invention.

FIG. 7 illustrates an example of a split of a cognitive map according to an embodiment of the invention.

FIG. 8 illustrates an example of a user interface for a website blog featuring a non-linear comment system according to an embodiment of the invention.

FIG. 9.1-9.4 illustrate an example of evolvement in time of the website blog user interface of FIG. 8 according to an embodiment of the invention, respectively illustrating states 1-4 of the evolvement.

FIG. 10 illustrates a network client server configuration for cognitive mapping according to an embodiment of the invention.

FIG. 11 illustrates a method for operating a cognitive engine to determine a cognitive association between two data objects and for creating/updating a cognitive mapping according to embodiments of the invention.

### DETAILED DESCRIPTION

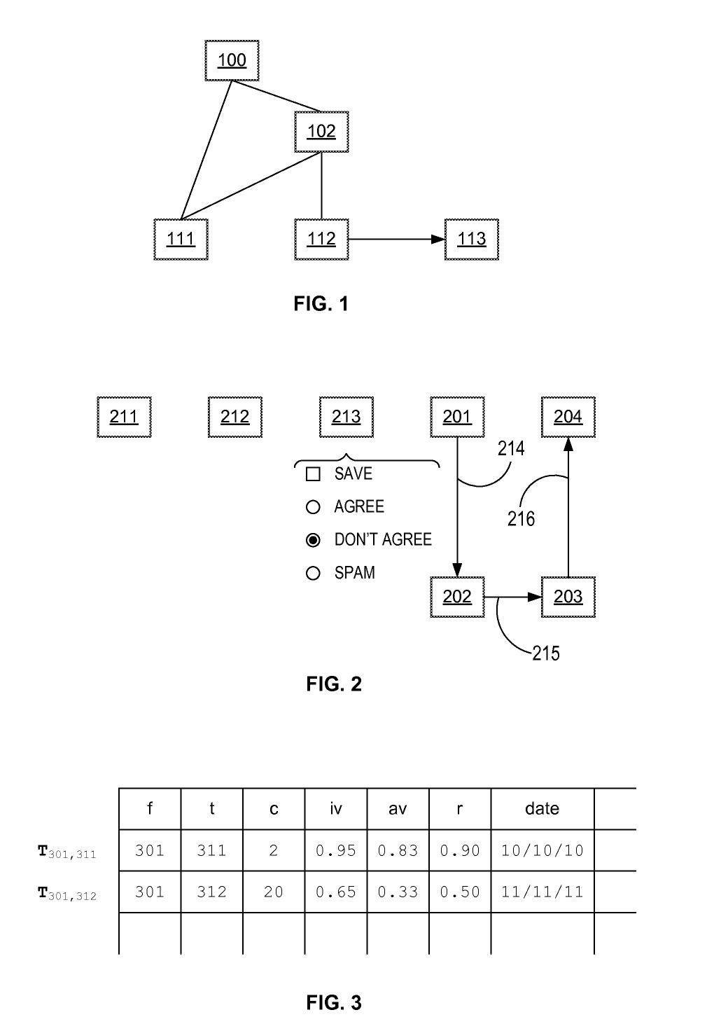

Reference is now made to FIG. 1 which illustrates typical relationships between data objects.

In an embodiment of the invention, data object 100 is created independently, not as a reaction to another data object. It is therefore defined as a “root data object”, or a data object that starts a new topic. In another embodiment of the invention, data object 100 is a pre-existing data object which the user accesses at the beginning of a topical search, and is thus defined as a “rood data object”.

Data object 102 is a reply to data object 100 which implies in the scope of the present invention that data object 100 is defined as a parent to data object 102.

Data object 111 is a reply to data objects 100 and 102 which implies in the scope of the present invention that data objects 100 and 102 are defined as parents to data object 111.

Data object 112 is a reply to data object 102, therefore data object 102 is a parent to data object 112, which implies that data objects 111 and 112 are defined as siblings.

The relationship between data objects 112 and 113 is defined as reference, e.g. data object 112 refers to data object 113.

Reference is now made to FIG. 2 which illustrates six possible reviewer behaviors.

Behavior 211 is defined by the present invention as “preview”. Preview is the action of reading, watching or listening to a shortened representation of a data object (e.g. a textual “punch line”, a movie trailer etc.).

Behavior 212 is defined by the present invention as “view”. View is the action of reading, watching or listening to the data object itself or part of it with no further reaction.

Behavior 213 is defined by the present invention as “react”. React is the action of previewing or viewing a data object then express opinion on it through known means such as rating radio buttons, “agree” or “spam” buttons.

Behavior 214 is defined by the present invention as “reply”. A reviewer replies to data object 201 by posting a new data object 202 as a reply to it. It is emphasized that in a non-linear comment system a single data object can be a reply to one or more data objects.

Behavior 215 is defined by the present invention as “refer”. A reviewer creates a reference between two data objects 202 and 203 by linking 202 to 203.

Behavior 216 is defined by the present invention as “follow”. A reviewer follows from data object 203 to a child, parent, sibling or referenced data object 204 by first reviewing data object 203 then, immediately after, reviewing data object 204.

It is emphasized that behaviors are not exclusive and may be combined.

Reference is now made to FIG. 3 which illustrates a “cognitive association table” T. The columns in table T are identified as f, t, c, iv, av and r. In the description hereinafter cells content will be marked as Tₙ [x] while x represents the column. Also in the description hereinafter it is assumed that each data object is identified by an exclusive ID code, where the value of the ID is implementation dependent (for example a unique global ID may be assigned by a central service to each data object newly added to the system). In each row n, Tₙ [f] and Tₙ [t] are the IDs of two data objects. Tₙ [c] is the number of times reviewers follow from Tₙ [f] to Tₙ[t]. Tₙ [r] is a number between 0 and 1 which indicates the cognitive association of Tₙ [t] to Tₙ [f]. Tₙ [iv] and Tₙ [av] are numbers between 0 and 1 which are used to calculate Tₙ [r]. The table may contain other columns whose values may assist in cognitive association calculation by known methods (example: a “data object date” column in systems that considers newer data objects to have a higher cognitive association than older ones). Each row is uniquely identified as T_{f,t} where f is the value in T_{f,t} [f] and t is the value in T_{f,t} [t].

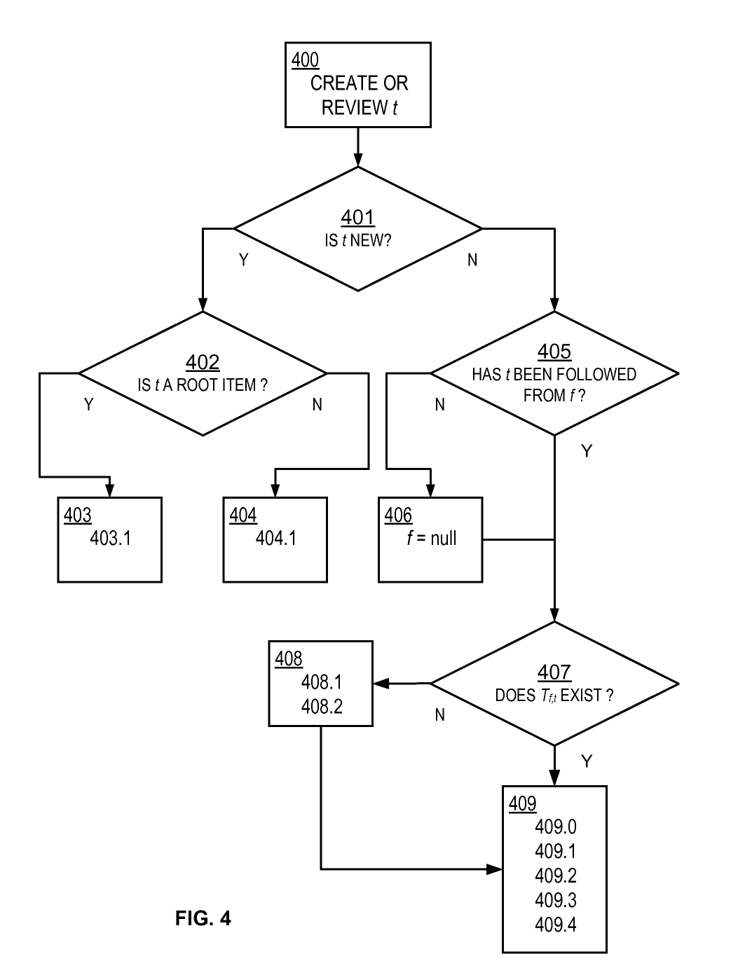

Reference is now made to FIG. 4, which illustrates an example of the process of cognitive association calculation according to an embodiment of the invention which uses a global cognitive association table T. The values in T are set by the algorithm described in FIG. 4 as follows:

Cognitive association calculation (400) takes place when either a data object t is created or every time it is reviewed. First a check is made (401) to determine whether this is a newly created data object or a review of an existing data object. If this is a new data object then a check is made (402) to determine whether this is a root data object or a reply to parent data objects.

Step 403 is performed when a reviewer creates a new root data object t. A root data object is a data object that has no parent, which is specified in the description hereinafter by using a parent ID of null. Step 403 includes execution of the following:

(403.1) T_{null,t}[f]=null; T_{null,t}[t]=t; T_{null,t}[c]=0; T_{null,t}[iv]=iv; T_{null,t}[av]=0, T_{null,t}[r]=iv;

where iv is an initial cognitive association value. The value iv is implementation dependent. It may be calculated as the average of all values T_{f,s}[r] for every f and for every s where the creator of s is also the creator of t, e.g. the average historical scoring of the creator of t. Further, a non-linear comment system may be controlled by an “owner” or a “moderator” who may decide that some data objects are considered “premium” content and therefore be assigned a higher iv value.

Examples:

(403.1.a) T_{null,431}[f]=null; T_{null,431}=[t]=431, T_{null,431}[c]=0; T_{null,431} [iv]=1.00; T_{null,431}[av]=0; T_{null,431}[r]=1.00;

(403.1.b) T_{null,432}[f]=null; T_{null,432}[t]=432; T_{null,432}[c]=0; T_{null,432}[iv]=1.00; T_{null,432}[av]=0; T_{null,432}[r]=0.75;

In example 403.1.a data object 431 is considered “premium” content then iv is set to 1.00.

In example 403.1.b iv is set according to the average historical scoring of the contributor of data object 432 which is 0.75.

Step 404 is performed when a reviewer creates a child data object t which has one or more parents pₙ (n>=1). Step 404 includes execution of the following:

(404.1) for each i in {1 . . . n}

{Tₚ_{ᵢ}_{,t}[f]=pᵢ; Tₚ_{ᵢ}_{,t}[t]=t; Tₚ_{ᵢ}_{,t}[c]=0; Tₚ_{ᵢ}_{,t}[iv]=iv; Tₚ_{ᵢ}_{,t}[av]=0; Tₚ_{ᵢ}_{,t}[r]=iv;}

where iv is an initial cognitive association value as above.

Example (404.1.1):

Data object 441 is a child of both data object 431 and data object 432, then step 402 is:

T_{431,441}[f]=431; T_{431,441}[t]=441; T_{431,441}[c]=0; T_{431,441}[iv]=0.60; T_{431,441}[av]=0; T_{431,441}[r]=0.60;

T_{432,441}[f]=432; T_{432,441}[t]=441; T_{432,441}[c]=0; T_{432,441}[iv]=0.60; T_{432,441}[av]=0; T_{432,441}[r]=0.60;

Step 405 is performed when an existing data object t is reviewed. First a check is made to determine whether t has been followed from an existing data object f. If not then f is set to null (406). A check is made (407) to determine whether a row T_{f,t} already exists in T. If not, step 408 is executed. Step 408 includes execution of the following:

(408.1) iv=F(T_{g,t}[r]) where {g in column T[f]}

(408.2) T_{f,t}[f]; T_{f,t}[t]=t; T_{f,t}[c]=0; T_{f,t}[iv]=iv; T_{f,t}[av]=0; T_{f,t} [r]=iv;

where F is a known function that operates on the values r for all the rows in which the value in column t equals t. F may be maximum or average. The result of function F is stored in a temporary value iv, which is then used to assign values in a newly created row T_{ft}.

Example (408.10):

Data object 441 is followed from data object 442. Row T_{442,441} does not exist, therefore the following is executed:

(408.1.a) iv=0.60=Max(T_{g,441}[r]) where {g in column T[f]}

(408.2.a) T_{442,441} [f]=442; T_{442,441}[t]=441; T_{442,441}[c]=0; T_{442,441}[iv]=0.60; T_{442,441}[av]=0; T_{442,441}[r]=0.60;

Step 409 is performed when a reviewer creates a reference from a data object f to a data object t, or follows from f to t. First a cognitive association value v is calculated:

(409.0) v=R(t);

R is an implementation-specific function which may be based on the following factors:
1. The ratio of viewing time of t in relation to its volume, e.g. in relation to the time it typically takes to review a data object of this volume in detail.
2. The behavior of the reviewer (as per FIG. 2) when reviewing t. For example when a reviewer posts a reply to t it implies that t has higher cognitive association than if t is only reviewed with no reaction.
3. The identity of the reviewer (for example the behavior of a reviewer whose own posts have high rating may be considered more significant than other reviewers).
4. Other implementation dependent factors such as, optionally, the IP address of the reviewer and the frequency of reviews from this IP address (it is desirable to eliminate the effect of bots. Other means to fight bots include MAC address of machines or phone numbers of mobile phones).

This is followed by the execution of following commands (* means ‘multiply’):

(409.1) T_{f,t}[av]=(T_{f,t}[av]*T_{f,t}[c]+v)/(T_{f,t}[c]+1);

(409.2) T_{f,t}[c]=T_{f,t}[c]+1;

(409.3) x=G(T_{f,t}[c]);

(409.4) T_{f,t}[r]=x*T_{f,t}[iv]+(1−x)*T_{f,t}[av];

Explanation to the commands of step 409:

v is a cognitive association value determined by the current review as explained hereinbefore.

(409.1) is a calculation of the average cognitive association value of all reviews so far. After each review a review counter is incremented in (409.2).

(409.3) is a calculation a value x as a function G of T_{f,t}[c]. G is any function resulting in a value between 0 and 1 which is used in (409.4) to factorize the weight of the initial cognitive association value iv vs. the accumulated value av depending on the number of reviews that follow from f to t (T_{f,t}[c]). A typical example of G is:

(409.3.1) x=1/(1+δ*T_{f,t}[c]+ε*T_{f,t}[c]²);

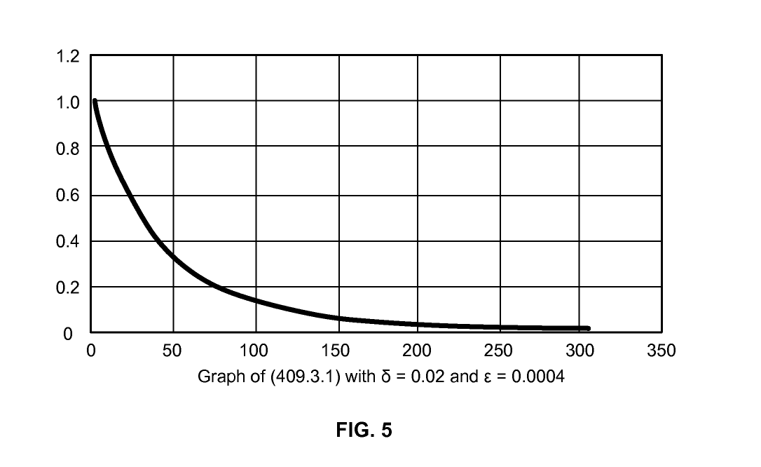

This function results in a hyperbolic graph where the result x is 1 when there are no reviews that follows from f to t, then decreases relatively sharply as the number of reviews increases and continues to decrease more moderately as the number of reviews becomes larger. ε and ε are non-negative constants which control the concavity of the function graph. FIG. 5 is an example of a graph depicting the function in (409.3.1).

Example:

Data object 441 is followed from data object 442. Row T_{442,441} exists, with values as per example 408.10 hereinabove. The following commands are executed:

v=0.80=R(441); (in this example R(441) yields 0.80 according to the options described hereinabove)

(409.1) T_{442,441}[av]=0.80=0*0+0.80/(0+1)=(T_{442,441}[av]*T_{442,441}[c]+v)/(T_{442,441}[c]+1);

(409.2) T_{442,441}[c]=1=0+1=T_{442,441}[c]+1;

(per example 409.3.1 and FIG. 5) x=0.9765625=1/(1+0.02*1+0.004*1²);

(409.4) T_{442,441}[r]=0.6046875=0.9765625*0.60+(1−0.9765625)*0.80=x*T_{442,441}[iv]+(1−x)*T_{442,441}[av];

Reference is now made to the definition of a topic in accordance with embodiments of the present invention. As stated hereinabove, two data objects are considered to belong to the same topic when it is likely that a reviewer of one data object will be interested to review the other data object. Embodiments of the present invention feature this principle through definitions of “cognitive association” and “topic” as follows:

Definition 4.1—Cognitive Association:

Data object qₙ is considered to have a non-zero cognitive association with data object q₀ if and only if there is a series of data objects q₀, q₁ . . . qₙ so that for each i<n T_{q}_{ᵢ}_{,q}_{ᵢ₊₁}[r]>=β.

β is a constant value between 0 and 1 that is used as a threshold for determining whether a data object qᵢ₊₁ has a significant cognitive association with a data object qᵢ. The value of β is implementation dependent. A higher value implies that the topic is defined by a higher value of cognitive association.

The present invention assumes dynamic cognitive association mapping among data objects. Consequently the present invention provides methods for merging and splitting cognitive association maps. The triggers to and effects of merge and split events are described below.

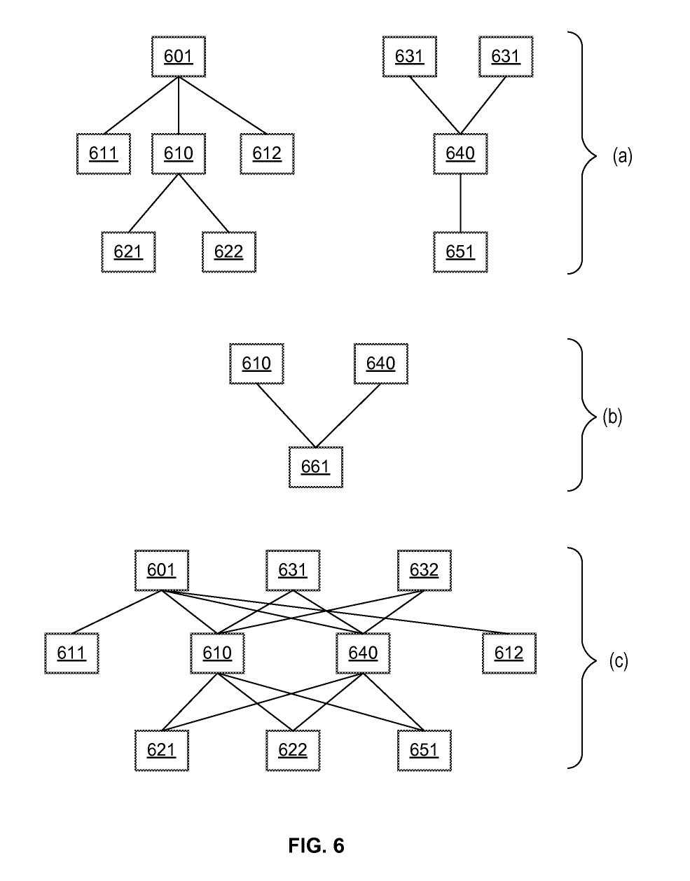

Reference is now made to FIG. 6 which illustrates an example of a merge in a non-linear comment system which is organized according to an embodiment of the present invention.

Part (a) of FIG. 6 illustrates the state of a sample system before a merge takes place. There are two cognitive association mappings in the figure. A first cognitive association map has a parent data object 601 with three children—610, 611 and 612. Data object 611 has two children, 621 and 622. A second cognitive association map has two data objects, 631 and 632, with a common child 640. Data object 640 has a child 651.

Part (b) of FIG. 6 exemplifies a merge. The trigger for a merge is implementation dependent. A merge takes place when a reviewer replies with a single data object to two or more data objects, in which case the data objects that are replied to are merged. Further, a merge takes place when a reviewer references one data object for another time, in which case the two data objects are merged. FIG. 6 exemplifies the first option by showing data object 661 as a reply to 610 and 640, in which 610 and 640 are merged.

Part (c) of FIG. 6 illustrates the result of the merge for the example of FIG. 6. According to an embodiment of the present invention, when two data objects or more are merged all parents, siblings, children and references of one of the merged data objects become parents, siblings and children of the other data object(s).

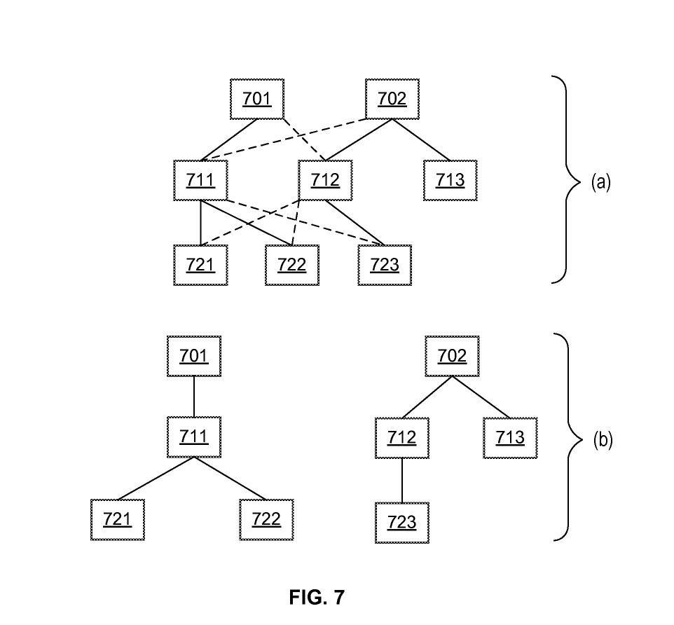

Reference is now made to FIG. 7 which illustrates an example of a split in a non-linear comment system which is organized according to an embodiment of the present invention.

Part (a) of FIG. 7 illustrates an example of a cognitive association map before a split takes place. Two data objects, 701 and 702, have common children 711, 712 and 713. 711 and 712 also have common children 721, 722 and 723. (Note that in FIG. 7 both solid and dashed lines indicate parent-child relationship. The difference between the two types of line will be clarified immediately hereinafter).

A split takes place when reviewers of the cognitive association map data objects judge part of the cognitive association map to have an insignificant cognitive association with another part of the cognitive association map, e.g. when the following sequence of conditions takes place (all symbols are per the explanation above):
1. There exists a topic (cognitive association map) A={a₀, a₁ . . . aₖ, aₖ₊₁ . . . aₙ};
2. A follow from aₖ to aₖ₊₁ as per step 409 above causes Tₐ_{ₖ}_{,a}_{ₖ₊₁}[r] to be <β and there is no other series by which aₖ₊₁ has a cognitive association with aₖ;
3. A splits into two cognitive association maps A₁={a₀, a₁ . . . aₖ} and A₂={aₖ₊₁ . . . aₙ};

The example illustrated in FIG. 7 assumes that reviewer behavior brings the cognitive association table to the following state:

| f | t | c | iv | av | r | comment |
|---|---|---|---|---|---|---|
| 701 | 711 | 5 | 1.0000 | 0.9500 | 0.9917 | |
| 701 | 712 | 50 | 0.8000 | 0.4000 | 0.4333 | below threshold |
| 702 | 711 | 80 | 0.9000 | 0.4500 | 0.4660 | below threshold |
| 702 | 712 | 70 | 0.8500 | 0.9500 | 0.9455 | |
| 702 | 713 | 2 | 0.8500 | 0.6000 | 0.8367 | |
| 711 | 721 | 5 | 0.7000 | 0.9000 | 0.7333 | |
| 711 | 722 | 30 | 0.6500 | 0.9000 | 0.8519 | |
| 711 | 723 | 18 | 0.8000 | 0.3000 | 0.4883 | below threshold |
| 712 | 721 | 10 | 0.7000 | 0.1000 | 0.4750 | below threshold |
| 712 | 722 | 100 | 0.8500 | 0.4400 | 0.4495 | below threshold |
| 712 | 723 | 10 | 0.7500 | 0.8800 | 0.7988 | |

The values in the table at this stage meet the condition of a split as defined hereinabove. This is illustrated in FIG. 7 by the dashed lines of part (a) of the figure, which illustrate relationship between data objects whose cognitive association with each other goes down to below the optional threshold value of 0.5.

Part (b) of FIG. 7 illustrates the state of the split cognitive association map after being split.

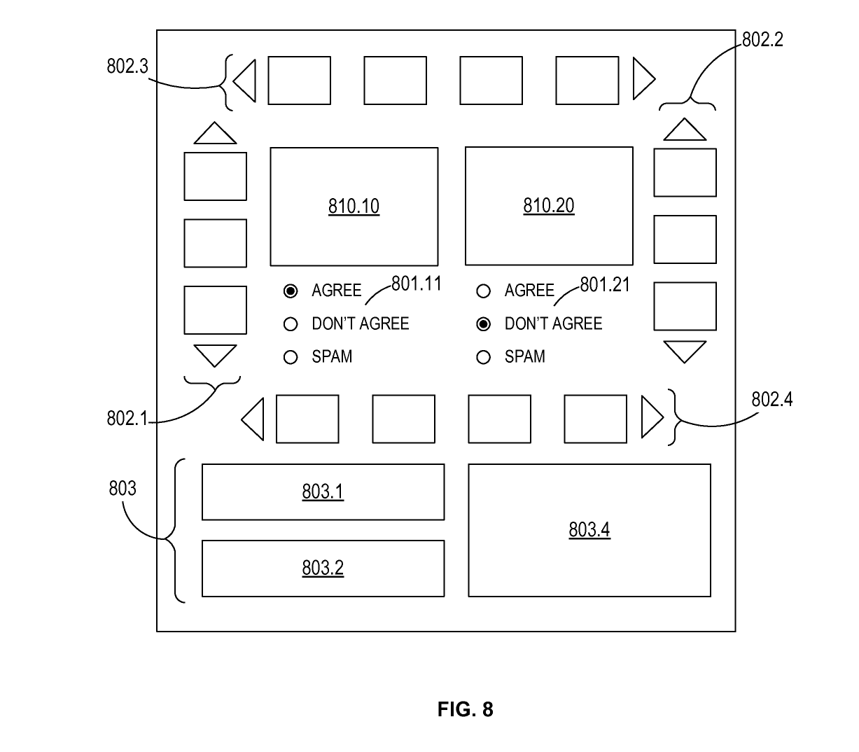

Reference is now made to FIG. 8 which illustrates an example of an optional PC user interface in a website blog featuring a non-linear comment system.

Screen section 801 illustrates an example of blog data objects that are in the process of review. In this example two data objects are in review. Screen sections 801.10 and 801.20 display two featured data objects in the same or difference website blogs. Below each data object there are reaction sections, 801.11 and 801.21 containing radio buttons by which a user can react to data objects 801.10 and 801.20 respectively.

Screen sections 802.1-802.4 display preview data objects related to the data objects in 801. 802.1 displays parents of both data objects in 801. 802.2 displays children of the data objects. 802.3 displays siblings of the data objects. 802.4 displays data objects referenced by the data objects. Each of these areas contains scroll buttons by which a user can scroll along the entire lists. The lists are ordered by cognitive association values according to embodiments of the present invention.

Screen section 803 is the reply section through which a user replies to the data objects in 801. In this example the reply is a textual data object. Preview text is typed in textbox 803.1. The full reply text is typed in textbox 803.2.

Screen section 804 contains a data object that is referenced by the reply data object in 803.

The user interface of FIG. 8 is a feature of an embodiment of the invention and is only one of many possible variations of the usage of the invention. Other embodiments feature user interface elements for the manipulation of the blog by an owner or moderator, user interface mechanism for the annotation of blog data objects, wiki-like editing features and more.

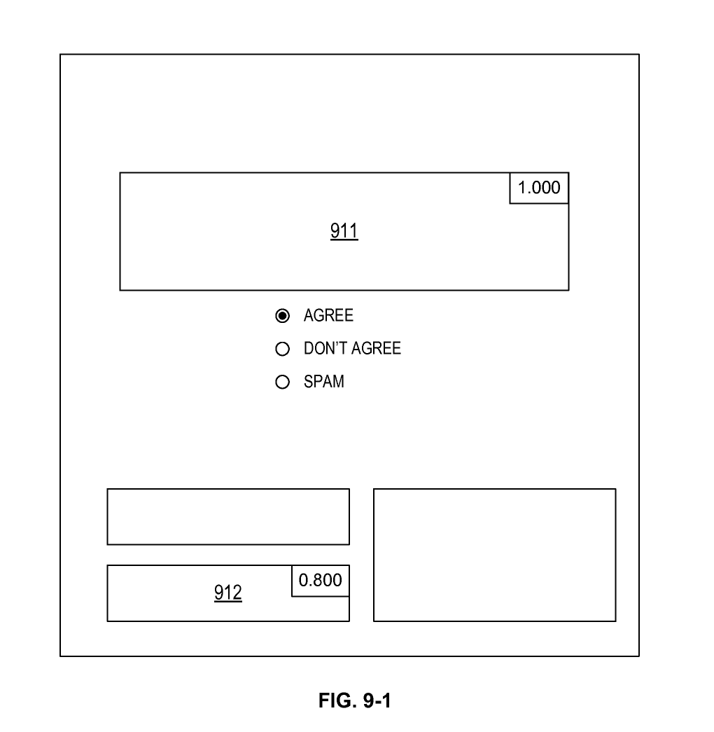

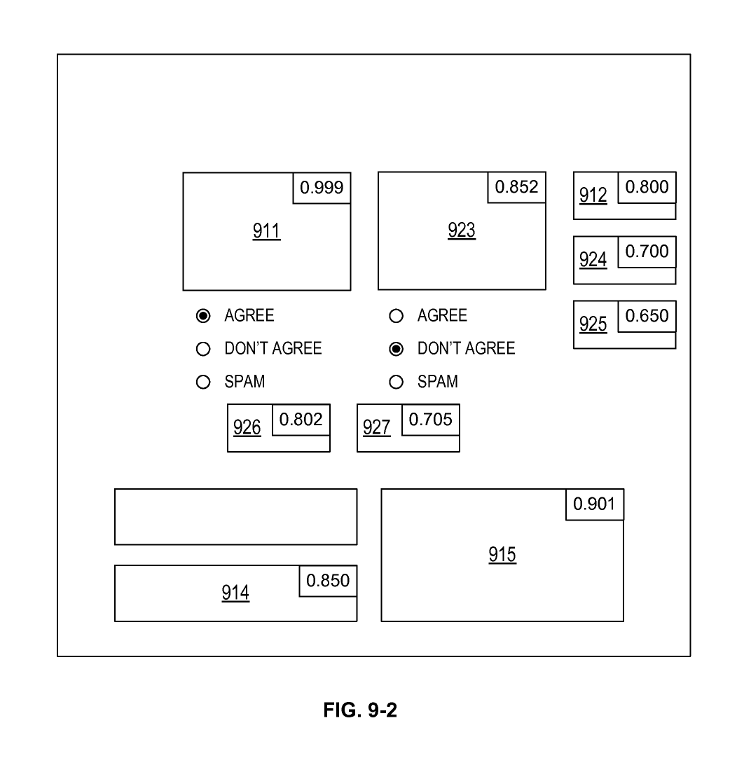

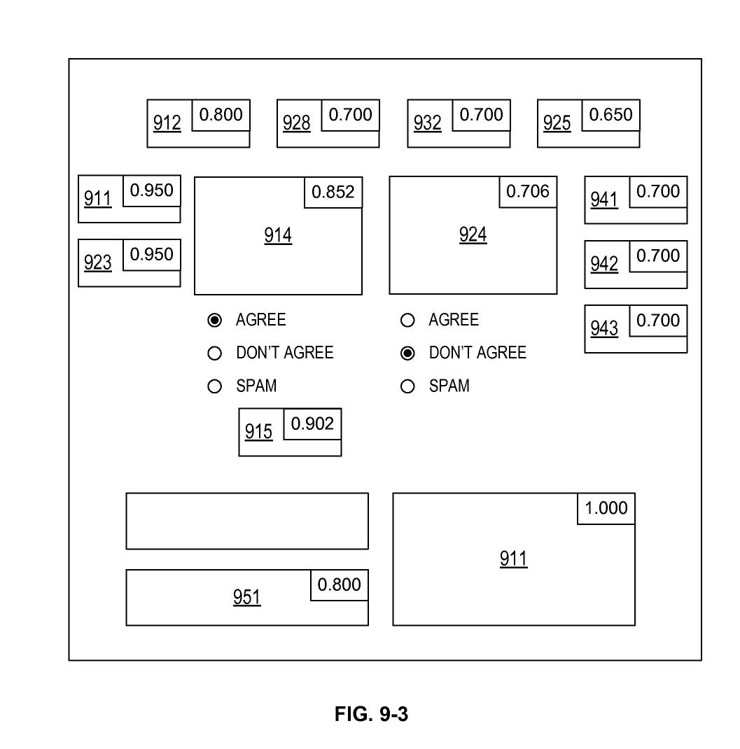

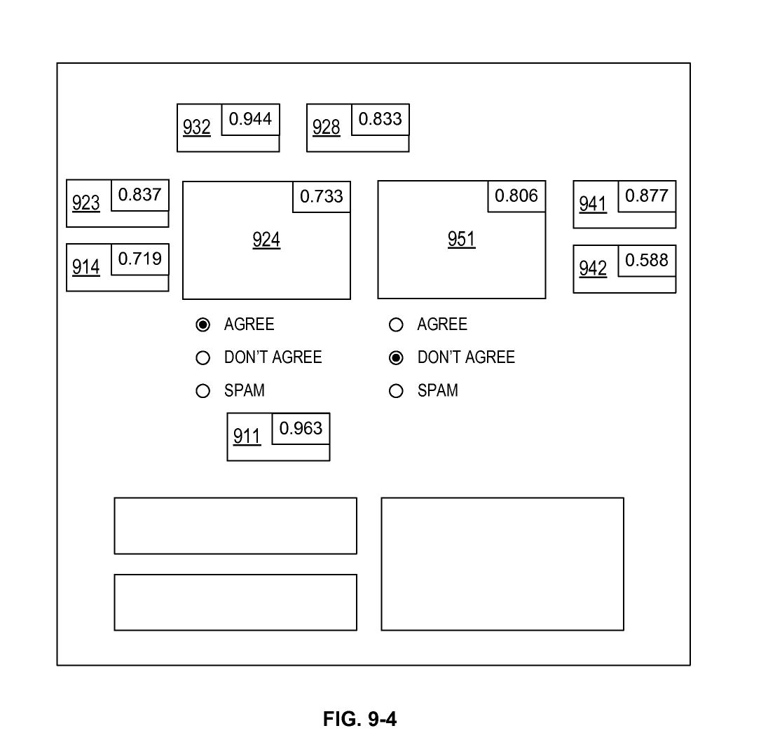

Reference is now made to FIGS. 9.1-9.4 which illustrate an example of evolvement in time of a website blog featuring a non-linear comment system as shown in FIG. 8 according to an embodiment of the present invention. In these figures the cognitive association of each data object to its surrounding data objects is illustrated by the small rectangles which contain a cognitive association value. It is noted that in these figures the order of cognitive association is illustrated by the location of a data object within other data objects of its group.

FIG. 9-1 is state 1 of the example. In this state a root data object 911 is presented and followed reviewer reaction of marking “agree” and then replying with data object 912. After the contribution of the two data objects the cognitive association table T contains the following values:

| f | t | c | iv | av | r | comment |
|---|---|---|---|---|---|---|
| null | 911 | 0 | 1.0000 | 0.0000 | 1.0000 | command (403.1) with |
| | | | | | | iv = 1.0000 |
| 911 | 912 | 0 | 0.8000 | 0.0000 | 0.8000 | command (404.1) with |
| | | | | | | iv = 0.8000 |

FIG. 9.2 is state 2 of the example. It is assumed that some data objects were posted to the blog in the time between state 1 and state 2. These data objects are 915 and 923 (root data objects), 924 and 925 (children of 923), 926 and 927 (referenced by 923). The status of the cognitive association table before state 2 is as follows:

| f | t | c | iv | av | r | comment |
|---|---|---|---|---|---|---|
| null | 911 | 0 | 1.0000 | 0.0000 | 1.0000 | command (403.1) with |
| | | | | | | iv = 1.0000 |
| 911 | 912 | 0 | 0.8000 | 0.0000 | 0.8000 | command (404.1) with |
| | | | | | | iv = 0.8000 |
| null | 915 | 0 | 0.9000 | 0.0000 | 0.9000 | command (403.1) with |
| | | | | | | iv = 9.0000 |
| null | 923 | 0 | 0.8500 | 0.0000 | 0.8500 | command (403.1) with |
| | | | | | | iv = 9.0000 |
| 923 | 924 | 0 | 0.7000 | 0.0000 | 0.7000 | command (404.1) with |
| | | | | | | iv = 0.7000 |
| 923 | 925 | 0 | 0.6500 | 0.0000 | 0.6500 | command (404.1) with |
| | | | | | | iv = 0.7000 |
| 923 | 926 | 1 | 0.8000 | 0.9000 | 0.8023 | Result of step 409 |
| 923 | 927 | 1 | 0.7000 | 0.9000 | 0.7047 | Result of step 409 |

State 2 includes the review of data objects 911, 923 and 915 and the addition of data object 914 as a reply (child) to both 911 and 923 and the call up of an existing data object 915 to be referenced by 914. At the end of state 2 the cognitive association table contains the following values:

| f | t | c | iv | av | r | comment |
|---|---|---|---|---|---|---|
| null | 911 | 1 | 1.0000 | 0.9500 | 0.9988 | Result of step 409 |
| 911 | 912 | 0 | 0.8000 | 0.0000 | 0.8000 | command (404.1) with |
| | | | | | | iv = 0.8000 |
| null | 915 | 1 | 0.9000 | 0.9500 | 0.9012 | Result of step 409 |
| null | 923 | 1 | 0.8500 | 0.9500 | 0.8523 | Result of step 409 |
| 923 | 924 | 0 | 0.7000 | 0.0000 | 0.7000 | command (404.1) with |
| | | | | | | iv = 0.7000 |
| 923 | 925 | 0 | 0.6500 | 0.0000 | 0.6500 | command (404.1) with |
| | | | | | | iv = 0.7000 |
| 923 | 926 | 1 | 0.8000 | 0.9000 | 0.8023 | Result of step 409 |
| 923 | 927 | 1 | 0.7000 | 0.9000 | 0.7047 | Result of step 409 |
| 911 | 914 | 0 | 0.8500 | 0.0000 | 0.8500 | command (404.1) with |
| | | | | | | iv = 0.8500 |
| 923 | 914 | 0 | 0.7500 | 0.0000 | 0.7500 | command (404.1) with |
| | | | | | | iv = 0.7500 |
| 914 | 915 | 1 | 0.9000 | 1.0000 | 0.9023 | Result of step 409 |

It is noteworthy that a merge takes place in State 2. FIG. 9.3 illustrates the result of this event by displaying together the common children of 912 and 923.

FIG. 9.3 is state 3 of the example. It is assumed that some data objects were posted to the blog in the time between state 2 and state 3. These data objects are 928 and 932 (children of 923), and 941, 942 and 943 (children of 924). The status of the cognitive association table before state 3 is as follows:

| f | t | c | iv | av | r | comment |
|---|---|---|---|---|---|---|
| null | 911 | 1 | 1.0000 | 0.9500 | 0.9988 | Result of step 409 |
| 911 | 912 | 0 | 0.8000 | 0.0000 | 0.8000 | command (404.1) with |
| | | | | | | iv = 0.8000 |
| null | 915 | 1 | 0.9000 | 0.9500 | 0.9012 | Result of step 409 |
| null | 923 | 1 | 0.8500 | 0.9500 | 0.8523 | Result of step 409 |
| 911 | 923 | 1 | 0.8500 | 0.9000 | 0.8512 | Result of step 409 |
| 923 | 924 | 0 | 0.7000 | 0.0000 | 0.7000 | command (404.1) with |
| | | | | | | iv = 0.7000 |
| 923 | 925 | 0 | 0.6500 | 0.0000 | 0.6500 | command (404.1) with |
| | | | | | | iv = 0.7000 |
| 923 | 926 | 1 | 0.8000 | 0.9000 | 0.8023 | Result of step 409 |
| 923 | 927 | 1 | 0.7000 | 0.9000 | 0.7047 | Result of step 409 |
| 911 | 914 | 0 | 0.8500 | 0.0000 | 0.8500 | command (404.1) with |
| | | | | | | iv = 0.8500 |
| 923 | 914 | 0 | 0.7500 | 0.0000 | 0.7500 | command (404.1) with |
| | | | | | | iv = 0.7500 |
| 914 | 915 | 1 | 0.9000 | 1.0000 | 0.9023 | Result of step 409 |
| 923 | 928 | 0 | 0.7000 | 0.0000 | 0.7000 | command (404.1) with |
| | | | | | | iv = 0.7000 |
| 923 | 932 | 0 | 0.7000 | 0.0000 | 0.7000 | command (404.1) with |
| | | | | | | iv = 0.7000 |
| 924 | 941 | 0 | 0.7000 | 0.0000 | 0.7000 | command (404.1) with |
| | | | | | | iv = 0.7000 |
| 924 | 942 | 0 | 0.7000 | 0.0000 | 0.7000 | command (404.1) with |
| | | | | | | iv = 0.7000 |
| 924 | 943 | 0 | 0.7000 | 0.0000 | 0.7000 | command (404.1) with |
| | | | | | | iv = 0.7000 |

State 3 includes the review of 914 (followed from 911) and 924 (followed from 923), side by side, and replying to both by posting data object 951. Also data object 911 is reviewed and is referenced by 951. After state 3 the table contains the following values:

| f | t | c | iv | av | r | comment |
|---|---|---|---|---|---|---|
| null | 911 | 1 | 1.0000 | 0.9500 | 0.9988 | Result of step 409 |
| 911 | 912 | 0 | 0.8000 | 0.0000 | 0.8000 | command (404.1) with |
| | | | | | | iv = 0.8000 |
| null | 915 | 1 | 0.9000 | 0.9500 | 0.9012 | Result of step 409 |
| null | 923 | 1 | 0.8500 | 0.9500 | 0.8523 | Result of step 409 |
| 911 | 923 | 1 | 0.8500 | 0.9000 | 0.8512 | Result of step 409 |
| 923 | 924 | 1 | 0.7000 | 0.9500 | 0.7059 | Result of step 409 with |
| | | | | | | v = 0.9500 |
| 923 | 925 | 0 | 0.6500 | 0.0000 | 0.6500 | command (404.1) with |
| | | | | | | iv = 0.7000 |
| 923 | 926 | 1 | 0.8000 | 0.9000 | 0.8023 | Result of step 409 |
| 923 | 927 | 1 | 0.7000 | 0.9000 | 0.7047 | Result of step 409 |
| 911 | 914 | 1 | 0.8500 | 0.9500 | 0.8523 | Result of step 409 with |
| | | | | | | v = 0.9500 |
| 923 | 914 | 0 | 0.7500 | 0.0000 | 0.7500 | command (404.1) with |
| | | | | | | iv = 0.7500 |
| 914 | 915 | 1 | 0.9000 | 1.0000 | 0.9023 | Result of step 409 |
| 923 | 928 | 0 | 0.7000 | 0.0000 | 0.7000 | command (404.1) with |
| | | | | | | iv = 0.7000 |
| 923 | 932 | 0 | 0.7000 | 0.0000 | 0.7000 | command (404.1) with |
| | | | | | | iv = 0.7000 |
| 924 | 941 | 0 | 0.7000 | 0.0000 | 0.7000 | command (404.1) with |
| | | | | | | iv = 0.7000 |
| 924 | 942 | 0 | 0.7000 | 0.0000 | 0.7000 | command (404.1) with |
| | | | | | | iv = 0.7000 |
| 924 | 943 | 0 | 0.7000 | 0.0000 | 0.7000 | command (404.1) with |
| | | | | | | iv = 0.7000 |
| 911 | 914 | 1 | 0.7000 | 0.9500 | 0.7059 | Result of step 409 |
| 914 | 951 | 0 | 0.8000 | 0.0000 | 0.8000 | command (404.1) with |
| | | | | | | iv = 0.8000 |
| 924 | 951 | 0 | 0.8000 | 0.0000 | 0.8000 | command (404.1) with |
| | | | | | | iv = 0.8000 |
| 951 | 911 | 1 | 1.0000 | 0.9900 | 0.9998 | Result of step 409 with |
| | | | | | | v = 0.9990 |

FIG. 9-4 is state 4 of the example. This state follows multiple reviews as demonstrated in the following table:

| | t | c | iv | av | r | comment |
|---|---|---|---|---|---|---|
| null | 911 | 1 | 1.0000 | 0.9500 | 0.9988 | Result of step 409 |
| 911 | 912 | 0 | 0.8000 | 0.0000 | 0.8000 | command (404.1) with |
| | | | | | | iv = 0.8000 |
| null | 915 | 1 | 0.9000 | 0.9500 | 0.9012 | Result of step 409 |
| null | 923 | 1 | 0.8500 | 0.9500 | 0.8523 | Result of step 409 |
| 911 | 923 | 2 | 0.8500 | 0.6000 | 0.8367 | Result of step 409 |
| 923 | 924 | 5 | 0.7000 | 0.9000 | 0.7333 | Result of step 409 |
| 923 | 925 | 30 | 0.6500 | 0.1000 | 0.2058 | Result of step 409 |
| 923 | 926 | 1 | 0.8000 | 0.9000 | 0.8023 | Result of step 409 |
| 923 | 927 | 1 | 0.7000 | 0.9000 | 0.7047 | Result of step 409 |
| 911 | 914 | 10 | 0.8500 | 0.5000 | 0.7188 | Result of step 409 |
| 923 | 914 | 0 | 0.7500 | 0.0000 | 0.7500 | command (404.1) with |
| | | | | | | iv = 0.7500 |
| 914 | 915 | 1 | 0.9000 | 1.0000 | 0.9023 | Result of step 409 |
| 923 | 928 | 20 | 0.7000 | 0.9000 | 0.8333 | Result of step 409 |
| 923 | 932 | 100 | 0.7000 | 0.9500 | 0.9442 | Result of step 409 |
| 924 | 941 | 40 | 0.7000 | 0.9000 | 0.8756 | Result of step 409 |
| 924 | 942 | 10 | 0.7000 | 0.4000 | 0.5875 | Result of step 409 |
| 924 | 943 | 25 | 0.7000 | 0.4000 | 0.4750 | Result of step 409 |
| 911 | 914 | 1 | 0.7000 | 0.9500 | 0.7059 | Result of step 409 |
| 914 | 951 | 2 | 0.8000 | 0.9000 | 0.8053 | Result of step 409 |
| 924 | 951 | 0 | 0.8000 | 0.0000 | 0.8000 | command (404.1) with |
| | | | | | | iv = 0.8000 |
| 951 | 911 | 25 | 1.0000 | 0.9500 | 0.9625 | Result of step 409 |

The prominent phenomenon in state 4 is the reduction in the amount of displayed data objects comparing to state 3. This is an exemplification of a split. As demonstrated in the table, the reason of the reduction is that as result of multiple reviews, some data objects took on an insignificant cognitive association with their surrounding data objects (the threshold in this example for determining cognitive association is an r value of 0.5), e.g. they were judged by the reviewers to be out of topic.

### Network Configuration

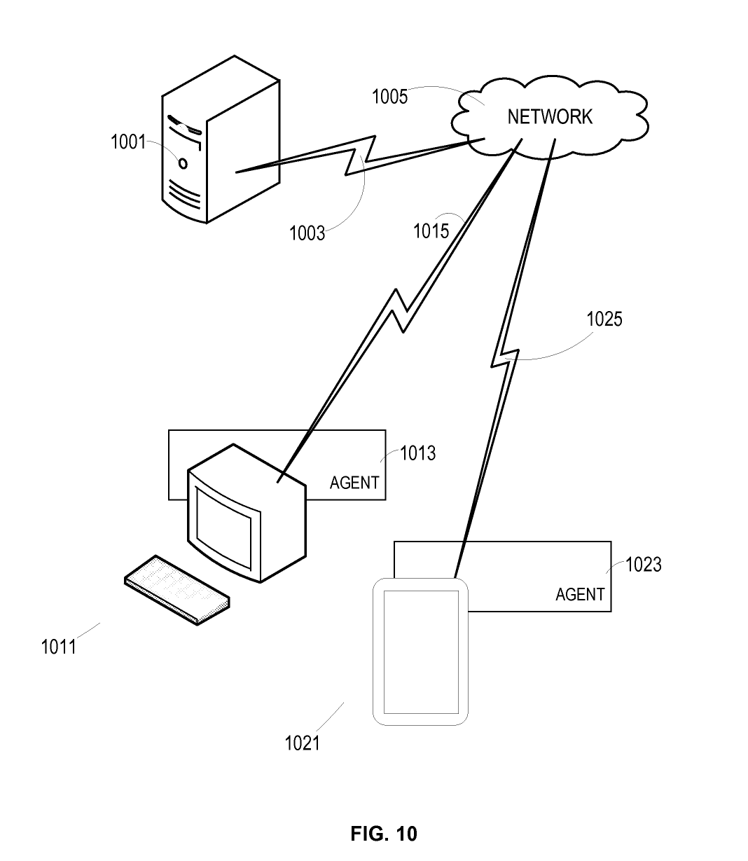

FIG. 10 illustrates a network configuration according to an embodiment of the invention. A server 1001 connected via a link 1003 to a network 1005 contains a software application for functioning as a “cognitive engine” for determining cognitive associations between data objects which are accessed and/or retrieved by a user via a user device, such as a personal computer 1011 connected to network 1005 via a link 1015, or a mobile device 1021 (such as a smart phone) connected to network 1005 via a link 1025.

Personal computer 1011 includes an agent 1013 which is a dedicated software application that has been downloaded and installed in personal computer 1011, which monitors user behavior in accessing and retrieving data objects, and which reports the user's monitored behavior to server 1001 via link 1015. Likewise, mobile device 1021 includes an agent 1023 which has been downloaded and installed therein, which monitors user behavior in accessing and retrieving data objects, and which reports the user's monitored behavior to server 1001 via link 1025.

### Cognitive Engine Method

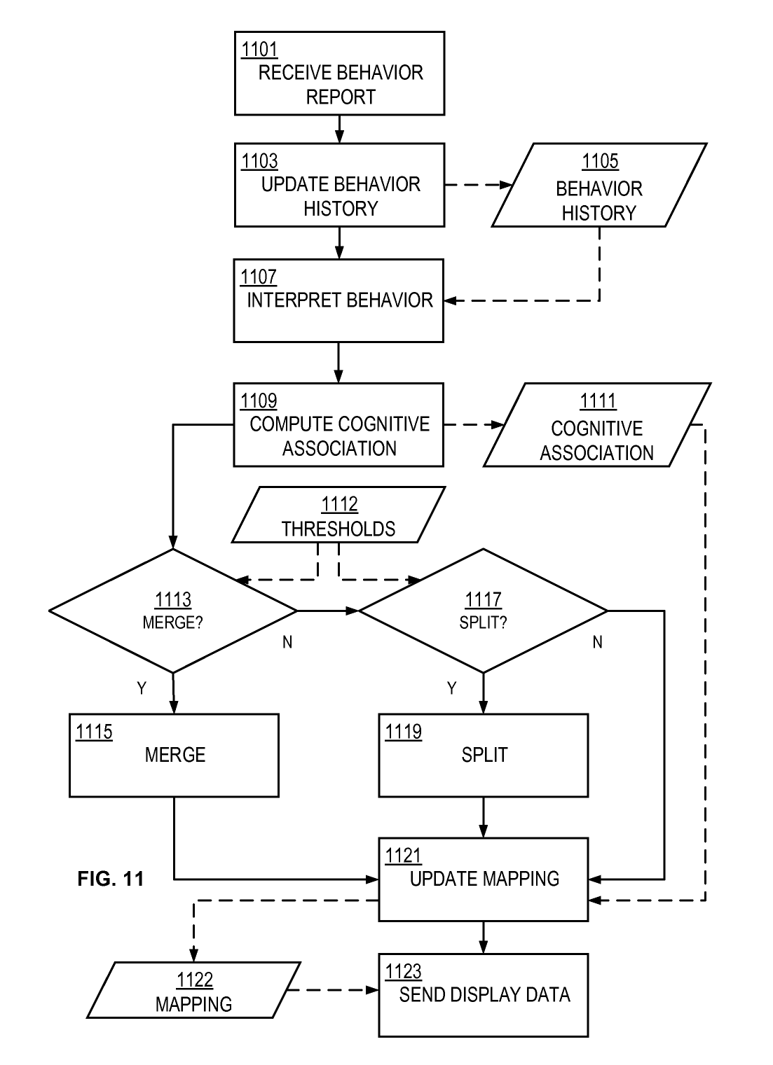

FIG. 11 illustrates a method for operating server 1001 as a cognitive engine to determine a cognitive association between two data objects and for creating/updating a cognitive mapping according to embodiments of the invention. In a step 1101 server 1001 receives a behavior report over network 1005 from a software agent (such as agent 1013), reporting the user's access behavior regarding data objects. Typical behaviors are defined and described previously, with regard to FIG. 1.

In a step 1103 server 1001 updates a behavior history 1105, which is a data structure stored by server 1001 in a tangible machine-readable non-transient data storage, for compiling a record of behaviors of the user. In a step 1107 server 1001 interprets the behavior history in order to compute a cognitive association 1111 in a step 1109. In an embodiment of the invention, cognitive association 1111 is a numerical data value stored by server 1001.

In an embodiment of the invention, at a decision point 1113 it is determined whether to merge two or more disjoint cognitive mappings into a single cognitive mapping, according to one or more thresholds 1112. If the decision to merge is made, then in a step 1115 the merge operation is performed. If no merge is to be performed, then at a decision point 1117 it is determined whether to split a single cognitive mapping into two or more disjoint cognitive mappings, according to one or more thresholds 1112. If the decision to split is made, then in a step 1119 the split is performed. Details of the merge and split operations are described in a previous discussion.

In a step 1121 a cognitive mapping 1022 is created or updated as appropriate, for organizing the data objects based on cognitive association 1111.

Finally, in a step 1123, server 1001 sends display data based on cognitive mapping 1022 to the user device (such as personal computer 1011) for display. In an embodiment of the invention, server 1001 sends display data to the dedicated agent (such as agent 1013) for handling.

According to certain embodiments of the invention, the display of cognitive mappings to the user is dependent on the application and implementation of the cognitive map display on the user device. In specific embodiments, the cognitive maps are explicitly displayed as graphs of nodes and edges. In other embodiments, the cognitive mappings are not explicitly displayed, and are implicitly shown in lists and outlines. In further embodiments, the cognitive mappings are not explicitly displayed, and are implicit in suggestions of data objects presented to the user. In still further embodiments, the server sends a response to the user based on a computed cognitive association and/or a cognitive mapping of the data objects. Additional embodiments handle display for the user in other manners according to the intended use and user preferences.

### Computer Product

A further embodiment of the present invention provides a computer product for performing any of the foregoing methods of embodiments of the present invention, or variants thereof.

A computer product according to this embodiment includes a set of executable commands for performing the method on a computer, wherein the executable commands are contained within a tangible computer-readable non-transient data storage medium including, but not limited to: computer media such as magnetic media and optical media; computer memory; semiconductor memory storage; flash memory storage; data storage devices and hardware components; and the tangible non-transient storage devices of a remote computer or communications network; such that when the executable commands of the computer product are executed, the computer product causes the computer to perform the method.

In this embodiment, a “computer” is any data processing apparatus for executing a set of executable commands to perform a method of the present invention, including, but not limited to: personal computer; workstation; server; gateway; router; multiplexer, demultiplexer; modulator, demodulator; switch; network; processor; controller; digital appliance, tablet computer; mobile device, mobile telephone; any other device capable of executing the commands.

What is claimed is:

1. A method for organizing a plurality of data objects into a cognitive mapping according to user behavior, the method comprising:
receiving, by a server connected to the network, a report from a dedicated software agent installed in a user device connected to the network, of a behavior of a user using the user device in accessing a first data object over the network;
storing, by the server, the report in a behavior history;
computing, by the server, a cognitive association of the first data object of the plurality with respect to a second data object of the plurality;
organizing, by the server, the first data object and the second data object in a cognitive mapping; and
sending, by the server, a response to the user device, wherein the response is based on the cognitive mapping.

2. The method of claim 1, further comprising: splitting the cognitive mapping into a plurality of disjoint cognitive mappings according to a predetermined threshold for the cognitive association.

3. The method of claim 1, further comprising: merging a plurality of disjoint cognitive mappings into the cognitive mapping according to a predetermined threshold for the cognitive association.

4. A system for organizing a plurality of data objects into a cognitive mapping according to user behavior, the method comprising:
a server connected to a network;
at least one user device for a user, wherein the user device is connected to the network; and
a dedicated software agent installed in the at least one user device;
wherein the server is operative to:
receive a report from the dedicated software agent of a behavior of the user in accessing a data object over the network;
store the report in a behavior history;
compute a cognitive association of a first data object of the plurality with respect to a second data object of the plurality;
organize the first data object and the second data object in a cognitive mapping; and
send a response to the user device, wherein the response is based on the cognitive mapping.

5. The system of claim 4, wherein the server is further operative to split the cognitive mapping into a plurality of disjoint cognitive mappings according to a predetermined threshold for the cognitive association.

6. The system of claim 4, wherein the server is further operative to merge a plurality of disjoint cognitive mappings into the cognitive mapping according to a predetermined threshold for the cognitive association.

7. A computer product for organizing a plurality of data objects into a cognitive mapping according to user behavior, the product comprising tangible non-transient computer-readable data storage that includes a set of executable commands for a computer, which commands, when executed by the computer, cause the computer to:
receive a report from a dedicated software agent installed in a user device, of a behavior of a user using the user device in accessing a first data object of the plurality over the network;
store the report in a behavior history;
compute a cognitive association of the first data object of the plurality with respect to a second data object of the plurality;
organize the first data object and the second data object in a cognitive mapping; and
send a response to the user device, wherein the response is based on the cognitive mapping.

8. The computer product of claim 7, wherein the product includes further executable commands which cause the computer to split the cognitive mapping into a plurality of disjoint cognitive mappings according to a predetermined threshold for the cognitive association.

9. The computer product of claim 7, wherein the product includes further executable commands which cause the computer to merge a plurality of disjoint cognitive mappings into the cognitive mapping according to a predetermined threshold for the cognitive association.
